(19) United States
(12) Patent Application Publication
(10) Pub. No.: US 2025/0159719 A1
(43) Pub. Date: May 15, 2025

(54) User Equipment Prioritization of Uplink Grants

(71) Applicant: Apple Inc., CUPERTINO, CA (US)

(72) Inventors: Ralf ROSSBACH, Munich (DE); Alexander SIROTKIN, Hod Hasharon (IL); Fangli XU, Beijing (CN); Haijing HU, Los Gatos, CA (US); Naveen Kumar R PALLE VENKATA, San Diego, CA (US); Pavan NUGGEHALLI, San Carlos, CA (US); Sethuraman GURUMOORTHY, San Ramon, CA (US); Yuqin CHEN, Beijing (CN); Zhibin WU, Los Altos, CA (US)

(21) Appl. No.: 18/837,299

(22) PCT Filed: Feb. 11, 2022
(86) PCT No.: PCT/CN2022/076069

§ 371 Date: Aug. 9, 2024

(51) Int. Cl. H04W 72/566; H04L 1/1812; H04W 72/1268

(52) U.S. Cl. CPC H04W 72/569; H04L 1/1812; H04W 72/1268

(57) ABSTRACT

A user equipment (UE) is configured to receive a first uplink grant having a first priority, generate, by a medium access control (MAC) layer, a first MAC protocol data unit (PDU) comprising first data, deliver the first MAC PDU to a physical (PHY) layer, transmit, via a Physical Uplink Shared Channel (PUSCH), the first data using resources identified in the first uplink grant, receive a second uplink grant having a second priority, wherein a corresponding PUSCH duration of the first and second uplink grants overlap and wherein the second priority is higher than the first priority, generate a second MAC protocol data unit (PDU) comprising second data corresponding to the second uplink grant, deliver the second MAC PDU to the PHY layer of the UE, cancel the transmission of the first data and transmit the second data using resources identified in the second uplink grant via the PUSCH.

### TECHNICAL FIELD

The present disclosure generally relates to communication, and in particular, to user equipment prioritization of uplink grants.

### BACKGROUND INFORMATION

In 5G NR, a user equipment (UE) may send uplink data to a network. Typically, this uplink data is sent during a time and on resources that are scheduled by a configured grant (CG) or a dynamic grant (DG). A DG may be considered to be grant based scheduling where the UE requests an uplink grant to send the data to the network. The DG may be requested via a scheduling request (SR) or any other mechanism. The UE receives the DG indicating the scheduled time and resources for the uplink on the Downlink Control Information (DCI) and sends the data to the network. A CG may be considered to be grant free scheduling where the network pre-configures the time and resources and assigns them to the UE without waiting for a request from the UE. However, the data that is to be sent in the uplink using the DG or CG may have different priorities and there should be a way to prioritize the DGs and/or CGs based on this priority.

### SUMMARY

Some exemplary embodiments are related to a processor of a user equipment (UE) configured to perform operations. The operations include receiving a first uplink grant having a first priority, generating, by a medium access control (MAC) layer of the UE, a first MAC protocol data unit (PDU) comprising first data corresponding to the first uplink grant, delivering, by the MAC layer, the first MAC PDU to a physical (PHY) layer of the UE, transmitting, by the PHY layer via a Physical Uplink Shared Channel (PUSCH), the first data using resources identified in the first uplink grant, receiving a second uplink grant having a second priority, wherein a corresponding PUSCH duration of the first and second uplink grants overlap and wherein the second priority is higher than the first priority, generating, by the MAC layer, a second MAC protocol data unit (PDU) comprising second data corresponding to the second uplink grant, delivering, by the MAC layer, the second MAC PDU to the PHY layer of the UE, cancelling the transmission of the first data and transmitting the second data using resources identified in the second uplink grant via the PUSCH.

Other exemplary embodiments are related to a user equipment (UE) having a transceiver configured to communicate with a network and a processor communicatively coupled to the transceiver and configured to perform operations. The operations include receiving a first uplink grant having a first priority, generating, by a medium access control (MAC) layer of the UE, a first MAC protocol data unit (PDU) comprising first data corresponding to the first uplink grant, delivering, by the MAC layer, the first MAC PDU to a physical (PHY) layer of the UE, transmitting, by the PHY layer via a Physical Uplink Shared Channel (PUSCH), the first data using resources identified in the first uplink grant, receiving a second uplink grant having a second priority, wherein a corresponding PUSCH duration of the first and second uplink grants overlap and wherein the second priority is higher than the first priority, generating, by the MAC layer, a second MAC protocol data unit (PDU) comprising second data corresponding to the second uplink grant, delivering, by the MAC layer, the second MAC PDU to the PHY layer of the UE, cancelling the transmission of the first data and transmitting the second data using resources identified in the second uplink grant via the PUSCH.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary timeline of a high priority (HP) Physical Uplink Shared Channel (PUSCH) being prioritized over a low priority (LP) PUSCH according to various exemplary embodiments.

FIG. 5 shows an exemplary uplink transmission flow within the UE according to various exemplary embodiments.

### DETAILED DESCRIPTION

The exemplary embodiments may be further understood with reference to the following description and the related appended drawings, wherein like elements are provided with the same reference numerals. The exemplary embodiments describe physical layer based uplink grant prioritization including modifications to the operation of both the physical layer and the medium access control layer of a UE to implement the uplink grant prioritization.

The exemplary embodiments are described with regard to a fifth generation (5G) network and a user equipment (UE) communicating with the network that support both configured grant (CG) scheduling and dynamic grant (DG) scheduling in the uplink. However, it should be understood that the exemplary embodiments are not limited to 5G networks and UEs and may be applied to any network/UEs that supports CG and DG scheduling.

In some exemplary embodiments, it will be described that the UE may prioritize overlapping high-priority CG Physical Uplink Shared Channel (PUSCH) and low-priority DG PUSCH (CG/DG overlap) or high-priority DG PUSCH and low-priority CG PUSCH (DG/CG overlap). This prioritization will take place in the physical (PHY) layer of the UE. However, there also needs to be changes to the Medium Access Control (MAC) layer of the UE to support this prioritization.

To support this prioritization, the PHY layer of the UE supports at least two priority levels for data that is to be transmitted in the uplink. As described above, these two priority levels may be high priority (HP) and low priority (LP). However, it should be understood that more than two levels of priority may also be supported using the principles described herein. It should also be understood that throughout this description the terms HP and LP may be used to describe the CGs and DGs. The priority levels of the grants may be identified by a priority index. For example, DGs may be received in Downlink Control Information (DCI) and the DCI may include a priority index corresponding to the DG. As described above, CGs are preconfigured by the network and each preconfigured CG may correspond to a priority index. Thus, the grants that are used to send the data may be described as LP or HP, e.g., HP CG, HP DG, LP CG, LP DG.

It should also be understood that the priority index refers to a priority at the PHY layer (e.g., PHY prioritization based on two priority levels identified by index 0,1). In contrast logical channel (LCH)-based prioritization is a separate and independent configuration in the MAC layer. Thus, the exemplary embodiments are related to the PHY layer prioritization and the corresponding operations to support this PHY layer prioritization. It should further be understood that a UE may be configured with both the LCH-based prioritization and the PHY layer prioritization but as described below, the PHY layer prioritization is primarily used when LCH-based prioritization is not configured. However, this does not preclude PHY layer prioritization and LCH-based prioritization being simultaneously configured. While the MAC layer may not evaluate the actual PHY priority level of the grant associated with a PUSCH during the grant prioritization, the MAC layer may be aware that the PHY layer is generally capable to prioritize one PUSCH over another, as further described below.

In addition, the grants will provide resources in the PUSCH to send the data, thus the PUSCH may also be characterized as a HP PUSCH or a LP PUSCH depending on the data that is being sent in the PUSCH. Furthermore, the exemplary embodiments are described with reference to overlapping CGs and DGs. It should be understood that overlapping refers to overlapped resources in the PUSCH duration (e.g., time) as scheduled by the DG or CG.

Some exemplary embodiments describe the MAC layer of the UE sending two MAC protocol data units (PDUs) to the PHY layer of the UE. The PHY layer may then prioritize the MAC PDUs based on the prioritization scheme. The prioritization scheme may then cancel a LP PUSCH and replace it with a HP PUSCH. As described above, to support this PHY layer prioritization scheme, the operations of the MAC layer may be modified to allow the MAC layer to send two MAC PDUs to the PHY layer and deliver the PUSCH grants associated with the MAC PDUs to the Hybrid Automatic Repeat Request (HARQ) entity for proper HARQ processing. These exemplary embodiments will be described in greater detail below.

Other exemplary embodiments describe the stopping of a timer (e.g., configuredGrantTimer) when a CG is cancelled/de-prioritized by a higher priority PUSCH. This may allow a CG that is configured with an autonomous transmission (e.g., autonomousTx) to perform a PUSCH transmission at the next available CG.

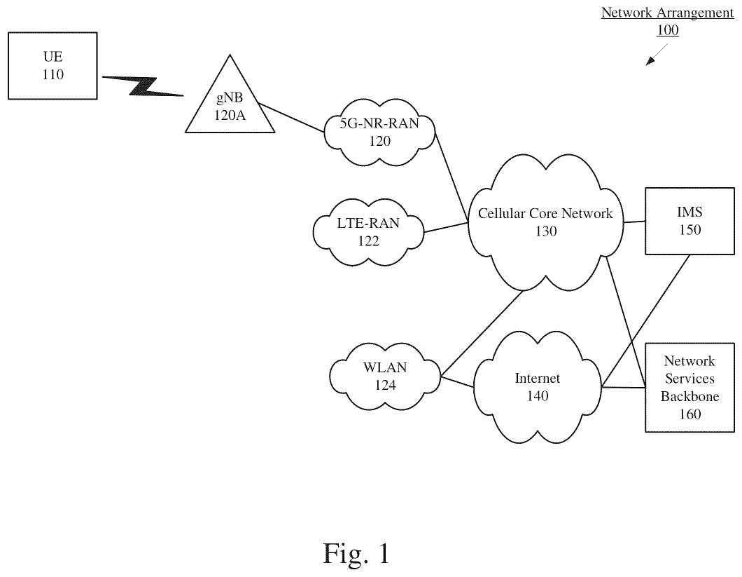

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., a component of a connected car, a mobile phone, a tablet computer, a smartphone, a phablet, an embedded device, a wearable, an Internet of Things (IoT) device, an Industrial IoT (IIoT) device, a Ultra-reliable low latency communications (URLLC) device, eXtended Reality (XR) devices, augmented reality (AR) devices, glasses, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, IAB nodes, network-controlled repeaters, smart repeaters, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN 120 via a next generation nodeB (gNB) 120A. The gNB 120A may be configured with the necessary hardware (e.g., antenna array), software and/or firmware to communicate with 5G NR-RAN capable devices such as the UE 110. Reference to one gNB 120A is merely for illustrative purposes. The UE 110 may also connect to the LTE-RAN 122 or to any other type of PAN, as mentioned above.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

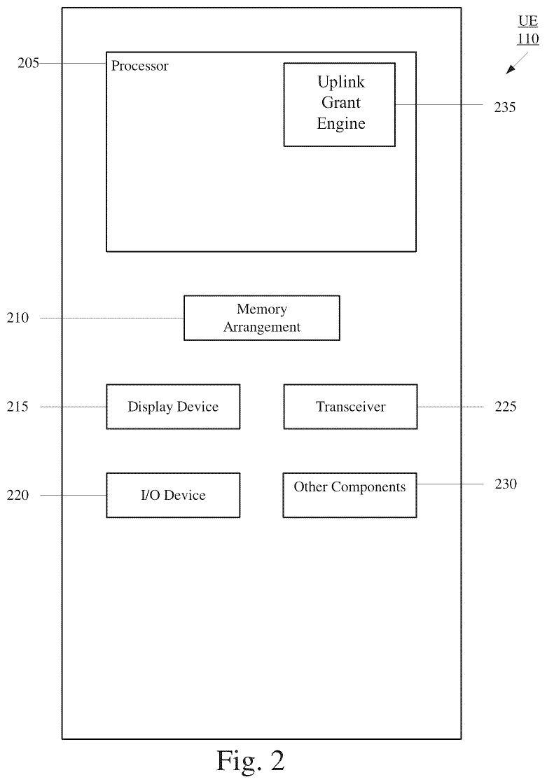

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an uplink grant engine 235. The uplink grant engine 235 may perform operations relating to the MAC layer and/or the PHY layer of the UE 110 to implement LCH and PHY based uplink grant reception, processing and prioritization. In addition, the uplink grant engine may perform operations related to the cancellation and replacement of uplink PUSCH transmissions by the PHY layer. The specific operations for various scenarios will be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

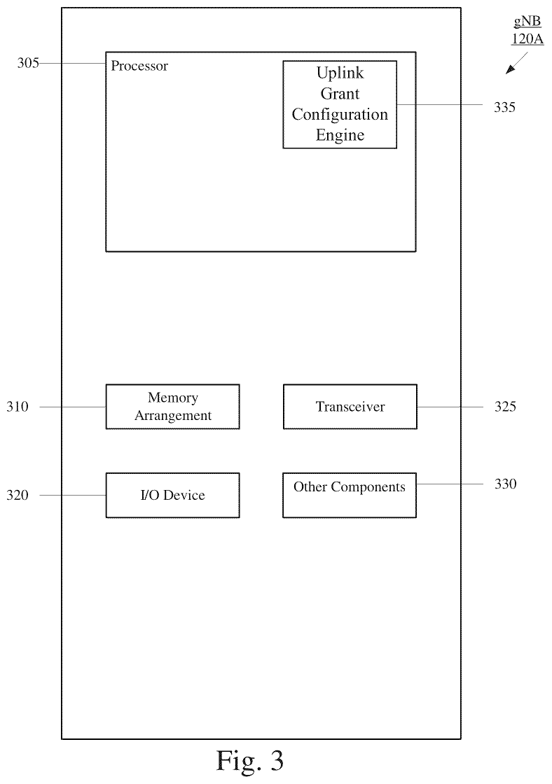

FIG. 3 shows an exemplary base station, in this case gNB 120A, according to various exemplary embodiments. The gNB 120A may represent any access node of the 5G NR network through which the UE 110 may establish a connection.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include an uplink grant configuration engine 335. The uplink grant configuration engine 335 may perform operations including configuring the UE 110 with the LCH and PHY based uplink grant prioritization and the scheduling of CGs and DGs. The specific operations for various scenarios will be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UE 110 and any other UE in the network arrangement 100. The transceiver 325 may operate on a variety of different frequencies or channels (e.g., set of consecutive frequencies). Therefore, the transceiver 325 may include one or more components (e.g., radios) to enable the data exchange with the various networks and UEs.

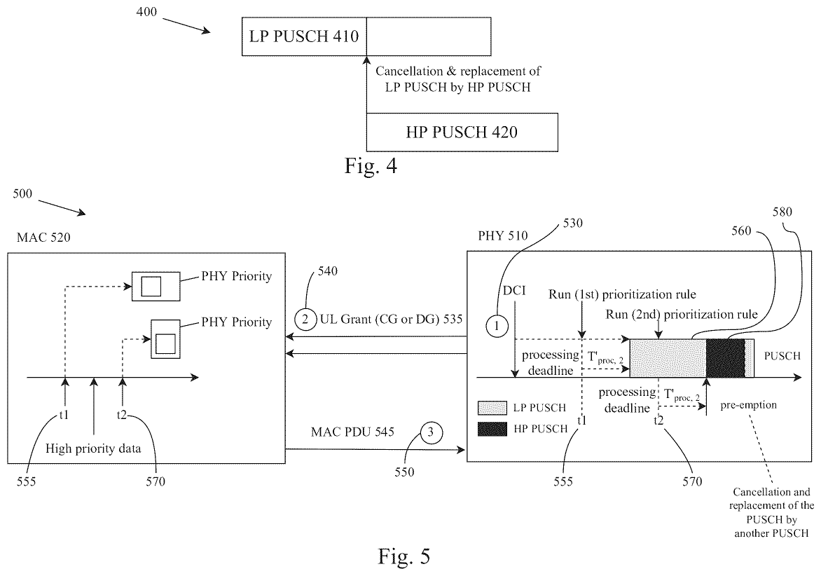

As described above, the UE 110 may support prioritization of a HP PUSCH 420 over a LP PUSCH 410 at the PHY layer. FIG. 4 shows an exemplary timeline 400 of a HP PUSCH being prioritized over a LP PUSCH. In FIG. 4, at a first time, uplink data is being transmitted via a LP PUSCH 410. At a second time, the UE 110 receives an HP PUSCH 420. This causes the PHY layer of the UE 110 to cancel the LP PUSCH 410 and replace it with the HP PUSCH 420, e.g., the HP PUSCH 420 processing overrides the LP PUSCH 410 in the PHY layer processing of the UE 110.

FIG. 5 shows an exemplary uplink transmission flow 500 within the UE 110 according to various exemplary embodiments. FIG. 5 shows the PHY layer 510 and the MAC layer 520 of the UE 110. Those skilled in the art will understand that transmission flow 500 is a simplified transmission flow and is meant to generally describe the stages of the uplink transmission flow and not every operation that occurs. As will be described in greater detail below, the transmission flow 500 may be an iterative process that is continuously repeated within the UE 110, i.e., the operations described below may be performed multiple times. In the following examples, it may be considered that the PHY layer 510 is configured with grant prioritization and the UE 110 is not configured with legacy operation where a DG always takes precedence over a CG.

In a first set of operations 530 of the flow, the PHY layer 510 receives grants. In a first example, the PHY layer 510 may receive DCI that includes a DG. In a second example, the PHY layer 510 encounters a preconfigured CG. The grant is then provided to the MAC layer 520 as shown by 535. It should be understood that there may be one or more grants provided to the MAC layer 520.

In a second set of operations 540, the MAC layer 520 may perform scheduling operations based on the grant(s) received from the PHY layer 510. In a first operation, the MAC layer 520 performs grant selection. The grant selection may be based on, for example, LCH-based prioritization considering the uplink timing budget and support of cancellation and replacement in the PHY layer 520. Grant selection may also be used if LCH-based prioritization is not configured. The MAC layer 520 may then perform logical channel prioritization (LCP) and generation of a MAC PDU. The MAC layer 520 may then deliver the MAC PDU to the PHY layer 510 as shown by 545. If another grant is available (e.g., as described above, the PHY layer 510 may send multiple grants during each iteration to the MAC layer 520), the MAC layer 520 may perform the above described operations for the grants that have not been processed. For ease of explanation, in this example first iteration, it may be considered that only a single LP grant was provided to the MAC layer 520 and a LP MAC PDU was provided to the PHY layer in 545.

Continuing with the exemplary uplink transmission flow 500, the PHY layer 510 performs a third set of operations 550 associated with the uplink transmission based on the scheduled PUSCH resources. To continue with the example started above, at time t1 555, the PHY layer 510 performs a prioritization operation. In this example, since there is only a LP PUSCH scheduled, the PHY layer 520 begins the LP PUSCH transmission 560 after a transmission processing delay.

However, as described above, the uplink transmission flow 500 is an iterative process and, the PHY layer may perform the first set of operations 530 again and deliver additional grants to the MAC layer 520. After t1 555, the MAC layer 520 may receive high priority data for uplink. The MAC layer 520 may then perform the second set of operations that result in a HP MAC PDU being sent to the PHY layer 520. The PHY layer 510 may then perform the third set of operations 550. For example, at a time t2 570, the PHY layer 510 performs a prioritization operation. In this example, since there is now a HP PUSCH 580, the PHY layer 510 will cancel and LP PUSCH 560 and replace it with the HP PUSCH 580 such that the PHY layer 520 begins the HP PUSCH 580 transmission after a transmission processing delay.

It should be understood that the above described uplink transmission flow 500 did not distinguish between CGs and DGs, e.g., when there is overlapping CGs and DGs, the operations may be performed to prioritize either a CG or DG based on the grant that has the higher priority.

As stated above, in 5G NR legacy operation of a UE, a DG always takes precedence over a CG when LCH-based prioritization is not configured. This may be accomplished by the MAC layer filtering out overlapping CGs during UL grant prioritization. However, to implement the above described uplink transmission flow 500 (e.g., PHY based grant prioritization) where a LP PUSCH may be cancelled and replaced with a HP PUSCH, the MAC layer 520 should be prevented from performing this filtering.

Specifically, the MAC layer 520 is prevented from filtering out a CG whose PUSCH duration is overlapping with the PUSCH duration of an uplink grant received on the PDCCH (e.g., a DG configured by DCI). This will enable the MAC layer 520 to deliver the overlapping CG to a Hybrid Automatic Repeat Request (HARQ) entity. Those skilled in the art will understand that NR supports HARQ processing that includes retransmissions and error correction. Retransmissions are controlled by the MAC layer 520. Thus, when a CG is not filtered out as may be the case in the uplink transmission flow 500, the MAC layer 520 needs to deliver the overlapping CG to the HARQ entity for the purposes of retransmissions of any packets associated with the CG. This allows the MAC layer 520 to deliver two MAC PDUs (e.g., a MAC PDU associated with a LP PUSCH and a MAC PDU associated with the HP PUSCH) to the PHY layer 510.

There are various manners to prevent the filtering of overlapping CGs by the MAC layer 520. In some exemplary embodiments, the NR standards (e.g., 3GPP standards) may be modified to indicate that if the cell group is configured with PHY layer prioritization between overlapping DG and CG PUSCH transmissions and the uplink grant is a CG, the overlapping CG is delivered to the HARQ entity and assigned a HARQ Process ID. As described above, this allows a MAC PDU associated with the CG to be delivered to the PHY layer 510 for uplink transmission and the MAC layer 520 to control any HARQ retransmissions for the uplink transmissions.

In other exemplary embodiments, new information elements (IEs) or parameters may be defined for the CGs to prevent the filtering of overlapping CGs by the MAC layer 520. For example, new Radio Resource Control (RRC) parameters may be defined the RRC PhysicalCellGroupConfig IE for a Cell Group in NR. Those skilled in the art will understand that these parameters are related to the PHY layer. The RRC parameters may be sent by the gNB 120A to the UE 110 to configure the UE 110 with the PHY layer grant prioritization.

One parameter is provisionally named prioritizationBetweenLP-DG-PUSCHandHP-CG-PUSCH. This parameter indicates that the network supports PHY prioritization for the case where a LP DG PUSCH collides with a HP CG PUSCH. Another parameter is provisionally named prioritizationBetweenHP-DG-PUSCHandLP-CG-PUSCH. This parameter indicates that the network supports PHY prioritization for the case where there are overlapping HP DG PUSCH and LP CG PUSCH on a bandwidth part (BWP) of a serving cell. It should be understood that the parameter names described above are only exemplary and other parameter names may be used in the PhysicalCellGroupConfig IE to indicate the above described functionalities. In addition, the parameters are not limited to being signaled via the PhysicalCellGroupConfig IE as they may be signaled in another RRC IE or in some other signaling scheme.

Similar to the above description for the PHY layer, new RRC parameters may also be defined for the MAC layer that correspond to the RRC parameters for the PHY layer. For example, a new parameter phy-basedPrioritization may be added to the mac-CellGroupConfig IE. The parameter may be enabled whenever the UE 110 is meant to support PHY layer 510 prioritization. For example, when one of the PHY layer parameters described above, e.g., prioritizationBetweenLP-DG-PUSCHandHP-CG-PUSCH or prioritizationBetweenHP-DG-PUSCHandLP-CG-PUSCH, is configured, the MAC layer 520 RRC parameter may also be configured. Again, it should be understood that the parameter name phy-basedPrioritization is only exemplary and other parameter names may be used in the mac-CellGroupConfig IE to indicate the above described functionalities. In addition, the parameter is not limited to being signaled via the mac-CellGroupConfig IE as it may be signaled in another RRC IE or in some other signaling scheme.

In the exemplary embodiments using the MAC layer RRC signaling parameters, the NR standards (e.g., 3GPP standards) may also be modified to support of the PHY layer prioritization between overlapping DG and CG PUSCH transmissions. In these exemplary embodiments, the standards may be revised to indicate that if the MAC layer is configured to support PHY layer prioritization (e.g., via the RRC parameter) and the uplink grant is a CG for the serving cell, the overlapping CG is delivered to the HARQ entity and assigned a HARQ Process ID. As described above, this allows a MAC PDU associated with the CG to be delivered to the PHY layer 510 for uplink transmission and the MAC layer 520 to control any HARQ retransmissions for the uplink transmissions.

In still further exemplary embodiments, the new IEs or parameters that are defined for the PHY layer may be used to prevent the filtering of overlapping CGs by the MAC layer 520. In the previous examples, several examples of RRC parameters to indicate PHY layer support of grant prioritization were described, e.g., prioritizationBetweenLP-DG-PUSCHandHP-CG-PUSCH or prioritizationBetweenHP-DG-PUSCHandLP-CG-PUSCH. When one of these parameters (or a similar parameter) enables the grant prioritization function in the PHY layer 510, this may also enable the skipping of CG pre-filtering in the MAC layer 520.

In the above examples, any parameter that indicates PHY layer support of grant prioritization may be used to enable the skipping of CG pre-filtering in the MAC layer 520. For example, instead of the specific grant prioritization parameters described above, there may be a single RRC parameter that indicates PHY layer support of grant prioritization, e.g., prioritizationBetweenLP-DG-PUSCHandHP-CG-PUSCH.

In the exemplary embodiments using the PHY layer RRC signaling parameters, the NR standards (e.g., 3GPP standards) may also be modified to support of the PHY layer prioritization between overlapping DG and CG PUSCH transmissions. In these exemplary embodiments, the standards may be revised to indicate that if the cell group enables grant prioritization (e.g., LP DG PUSCH and HP CG PUSCH or HP DG PUSCH and LP CG PUSCH) and the uplink grant is a CG for the serving cell, the overlapping CG is delivered to the HARQ entity and assigned a HARQ Process ID. As described above, this allows a MAC PDU associated with the CG to be delivered to the PHY layer 510 for uplink transmission and the MAC layer 520 to control any HARQ retransmissions for the uplink transmissions.

As described above, some exemplary embodiments describe the stopping of a timer (e.g., configuredGrantTimer) when a CG is cancelled/de-prioritized by a higher priority PUSCH. The MAC procedures employ a configuredGrantTimer that is maintained per HARQ process. When the timer expires, it indicates HARQ-ACK for the associated HARQ process. A function of the configuredGrantTimer is to protect the HARQ process associated with a CG from being overridden by a DG, e.g., to avoid the transport block (TB) from being overwritten in the buffer. Thus, while the configuredGrantTimer is running, both new transmissions and retransmissions are prohibited for the HARQ process associated with the timer.

The UE 110 may also be configured with an autonomousTx function that allows the UE 110 to autonomously transmit the CG after expiration of the configuredGrantTimer. This allows the UE 110 to autonomously transmit a CG UL PUSCH that was deprioritized. However, the configuredGrantTimer is started at the beginning of the first symbol of the CG-PUSCH transmission. If the CG gets deprioritized by a DG-PUSCH when the configuredGrantTimer is already running, the configuredGrantTimer may prohibit autonomous transmission on a subsequent CG resource. This is not desirable from a spectrum efficiency and delay perspective. Therefore, the configuredGrantTimer should be stopped when the CG-PUSCH is cancelled by a DG-PUSCH of higher PHY-priority.

Thus, when a CG-PUSCH transmission is cancelled in the physical layer due to PHY layer grant prioritization (e.g., by a high PHY-priority DG-PUSCH transmission), there are also corresponding MAC layer changes that may be implemented. In a first example, the uplink grant associated with the CG-PUSCH should be considered a de-prioritized grant (in order for the grant to not interfere with the grant prioritization of other UL grants). In a second example, the configuredGrantTimer associated with the CG should be stopped. This enables a subsequent CG resource (of the same CG config) to be used for autonomous transmission. These exemplary changes to the MAC layer operation may be implemented in a variety of manners. Some examples are provided below.

In some exemplary embodiments, when the PHY layer 510 cancels the CG-PUSCH at a time after uplink grant processing has already occurred, e.g., when a first MAC PDU was prepared and prioritization of a subsequent UL grant occurs, MAC layer operation may be modified by standards (e.g., 3GPP standards). For example, the standards may be modified to indicate that if a PUSCH transmission of an uplink grant is cancelled by the PHY for a HP PUSCH transmission, the cancelled grant is considered a de-prioritized uplink grant. By defining the cancelled uplink grant as a de-prioritized uplink grant, this accomplishes the above two example MAC modifications, e.g., the grant does not interfere with the grant prioritization of other UL grants and the configuredGrantTimer associated with the CG is stopped.

In other exemplary embodiments, a CG may be de-prioritized due to reception of a higher priority DG at the MAC layer 520. Thus, MAC layer 520 operation should be defined to handle this case. This operation may be defined as, when an uplink grant associated with a CG is de-prioritized due to a DG UL grant of higher LCH priority, the uplink grant associated CG should be considered a de-prioritized grant (in order for the grant to not interfere with the grant prioritization of other UL grants) and the configuredGrantTimer should be stopped. This enables a subsequent CG resource to be used for autonomous transmission. This may be defined in the standards as, if the de-prioritized uplink grant is a CG configured with autonomousTx and the PUSCH has already started, stop the configuredGrantTimer associated with HARQ process of the de-prioritized CG.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, an ARM-based platform, a Windows OS, a Mac platform and MAC OS, a mobile device having an operating system such as iOS, Android, a real-time embedded operating system, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
process a first uplink grant having a first priority;
generate, by a medium access control (MAC) layer, a first MAC protocol data unit (PDU) comprising first data corresponding to the first uplink grant;
deliver, by the MAC layer, the first MAC PDU to a physical (PHY) layer;
prepare, for transmission by the PHY layer via a Physical Uplink Shared Channel (PUSCH), the first data using resources identified in the first uplink grant;
process a second uplink grant having a second priority, wherein a corresponding PUSCH duration of the first and second uplink grants overlap and wherein the second priority is higher than the first priority;
generate, by the MAC layer, a second MAC protocol data unit (PDU) comprising second data corresponding to the second uplink grant;
deliver, by the MAC layer, the second MAC PDU to the PHY layer;
cancel the transmission of the first data; and
prepare the second data for transmission using resources identified in the second uplink grant via the PUSCH.

2. The apparatus of claim 1, wherein the first uplink grant is one of a configured grant or a dynamic grant and the second uplink grant is an other one of the configured grant or the dynamic grant.

3. The apparatus of claim 2, further configured to:
deliver, by the MAC layer, the first uplink grant and associated first Hybrid Automatic Repeat Request (HARQ) information to a HARQ entity; and
deliver, by the MAC layer, the second uplink grant and associated second HARQ information to the HARQ entity.

4. The apparatus of claim 3, wherein the PHY layer is configured to prioritize uplink grants based on a priority of the uplink grants.

5. The apparatus of claim 3, further configured to:
process a radio resource control (RRC) parameter configuring the MAC layer to prioritize uplink grants based on a priority of the grants, wherein the RRC parameter is associated with at least one RRC parameter configuring the PHY layer to prioritize uplink grants based on the priority of the grants.

6. The apparatus of claim 3, further configured to:
process a radio resource control (RRC) parameter configuring the PHY layer to prioritize uplink grants based on a priority of the grants.

7. The apparatus of claim 3, wherein logical channel (LCH)-based prioritization is not configured.

8. The apparatus of claim 1, wherein the first priority and the second priority are indicated by a priority index in the corresponding uplink grant.

9. The apparatus of claim 1, wherein the first uplink grant is a configured grant and the second uplink grant is a dynamic grant, further configured to:
start a timer when the first data is transmitted on the PUSCH; and
stop the timer when the transmission of the first data is cancelled.

10. The apparatus of claim 9, wherein the PHY layer cancels the transmission of the first data, configured to:
de-prioritize the first uplink grant.

11. The apparatus of claim 9, wherein the MAC layer cancels the transmission of the first data, further configured to:
de-prioritize the first uplink grant.

12. The apparatus of claim 9, wherein the first data is autonomously transmitted during a subsequent configured grant.

13. A user equipment (UE), comprising:
a transceiver configured to communicate with a network; and
a processor communicatively coupled to the transceiver and configured to:
process a first uplink grant having a first priority;
generate, by a medium access control (MAC) layer of the UE, a first MAC protocol data unit (PDU) comprising first data corresponding to the first uplink grant;
deliver, by the MAC layer, the first MAC PDU to a physical (PHY) layer of the UE;
prepare the first data for transmission by the PHY layer via a Physical Uplink Shared Channel (PUSCH) using resources identified in the first uplink grant;
process a second uplink grant having a second priority, wherein a corresponding PUSCH duration of the first and second uplink grants overlap and wherein the second priority is higher than the first priority;
generate, by the MAC layer, a second MAC protocol data unit (PDU) comprising second data corresponding to the second uplink grant;
deliver, by the MAC layer, the second MAC PDU to the PHY layer of the UE;
cancel the transmission of the first data; and
prepare the second data for transmission using resources identified in the second uplink grant via the PUSCH.

14. The UE of claim 13, wherein the first uplink grant is one of a configured grant or a dynamic grant and the second uplink grant is an other one of the configured grant or the dynamic grant.

15. The UE of claim 14, wherein the processor is further configured to:
deliver, by the MAC layer, the first uplink grant and associated first Hybrid Automatic Repeat Request (HARQ) information to a HARQ entity of the UE; and
deliver, by the MAC layer, the second uplink grant and associated second HARQ information to the HARQ entity of the UE.

16. The UE of claim 15, wherein the PHY layer of the UE is configured to prioritize uplink grants based on a priority of the uplink grants.

17. The UE of claim 14, wherein the processor is further configured to:
process a radio resource control (RRC) parameter configuring the MAC layer of the UE to prioritize uplink grants based on a priority of the grants, wherein the RRC parameter is associated with at least one RRC parameter configuring the PHY layer to prioritize uplink grants based on the priority of the grants.

18. The UE of claim 14, wherein the processor is further configured to:
process a radio resource control (RRC) parameter configuring the PHY layer of the UE to prioritize uplink grants based on a priority of the grants.

19. The UE of claim 15, wherein the UE is not configured with logical channel (LCH)-based prioritization.

20. The UE of claim 13, wherein the first priority and the second priority are indicated by a priority index in the corresponding uplink grant.

21-24. (canceled)
